(19) United States
(12) Patent Application Publication
(10) Pub. No.: US 2011/0132252 A1
(43) Pub. Date: Jun. 9, 2011

(54) PORTABLE BOAT CASTING DECK

(75) Inventor: Alex R. Kaye, Atherton, CA (US)

(73) Assignee: Alex R. Kaye and Frances Kaye Trust, Atherton, CA (US)

(21) Appl. No.: 12/634,516

(22) Filed: Dec. 9, 2009

(51) Int. Cl. B63B 3/48; B63B 17/00; B63B 7/00; F16M 13/02

(52) U.S. Cl. 114/362; 114/85; 114/363; 248/640

(57) ABSTRACT

Removable deck assemblies for boats, boats having removable deck assemblies, and permanently installed deck assemblies for boats are disclosed. A removable deck assembly includes a deck panel and a structure for removably attaching the deck panel in a bow of the boat. The structure supports the deck panel in a stable, substantially horizontal manner. The removable deck assembly can be adapted to be attached to various types of boats, including rigid inflatable boats, collapsible boats, inflatable boats, and rigid boats. The removable deck assembly can include additional features, for example, a deployable swim ladder, a pedestal seat support fitting, an outboard motor mount, a fishing pole holder, and/or an anchor line management fitting.

### BACKGROUND

Portable boats are popular with, for example, sportsmen and the like. Many such boats are relatively inexpensive and easily transportable, which contributes to their affordability and convenience. Such boats come in a wide range of configurations.

One popular configuration is a rigid boat that includes, for example, a pointed hull having a planar transom. Such rigid boats can be fabricated from a range of known materials, for example, polypropylene, aluminum, wood, fiberglass, and the like. Often, such rigid boats include a number of traverse seats.

Another popular configuration is a collapsible boat. Collapsible boats are well known in the boating field. Exemplary collapsible boats are disclosed in U.S. Pat. Nos. 4,556,009; 4,660,499; and 5,524,570. Many existing collapsible boats are light enough to be carried by a single person when collapsed.

Another popular configuration is an inflatable boat. Inflatable boats are also well known in the boating field. Many existing inflatable boats have inflatable side members and seats disposed between the inflatable side members.

Hybrids of the above-listed configurations also exist. Such hybrid configurations include, for example, rigid inflatable boats (often called “RIBS”), which have a solid, shaped hull and flexible tubes at the gunwale.

Because of the continuing need for portable boats, improvements are always sought. Thus, there is believed to be a need for a portable boat with enhanced features.

### BRIEF SUMMARY

The following presents a simplified summary of some embodiments of the invention in order to provide a basic understanding of the invention. This summary is not an extensive overview of the invention. It is not intended to identify key/critical elements of the invention or to delineate the scope of the invention. Its sole purpose is to present some embodiments of the invention in a simplified form as a prelude to the more detailed description that is presented later.

Removable deck assemblies for boats, and boats having removable deck assemblies, are provided. The disclosed removable deck assemblies can be used to add one or more beneficial features to a boat. For example, the disclosed deck assemblies can create a deck area of a boat in, for example, the bow of the boat. The disclosed deck assemblies can also provide additional features, for example, a deployable swim ladder, an outboard motor mount, an anchor line management fitting, and/or a pedestal seat support fitting. Such additional features may provide significantly increased functionality and/or convenience.

Thus, in a first aspect, a removable deck assembly for a boat is provided. The deck assembly includes a deck panel and a structure for removably attaching the deck panel in a bow of the boat. The structure supports the deck panel in a stable, substantially horizontal manner.

In many embodiments, an aft portion of the deck panel is supported. For example, the aft portion of the deck panel can be adapted to be supported by a seat of the boat when the deck assembly is installed in the boat. The deck assembly can also include an aft support structure adapted to interface with a hull of the boat to support a portion of the deck panel when the deck assembly is installed in the boat.

In many embodiments, the deck assembly includes edge members attached to the deck panel. For example, a port edge member can be attached to the deck panel and contact a port side hull member of the boat. And a starboard edge member can be attached to the deck panel and contact a starboard side hull member of the boat. The boat can include a V-hull and the edge members can wedge against an upper portion of the V-hull. Each of the port and starboard edge members can include at least one attachment feature to attach the edge member to the corresponding hull member.

In many embodiments, the structure includes support fittings that interface with hull members of the boat. For example, the structure can include a port support fitting adapted to interface with a port side hull member of the boat so as to provide vertical support to the deck assembly. And the structure can include a starboard support fitting adapted to interface with a starboard side hull member of the boat so as to provide vertical support to the deck assembly. Each of the port and starboard support fittings can include an inverted J-shaped member adapted to interface with the corresponding hull member.

In many embodiments, the deck assembly includes a seat fitting coupled with the deck panel. The seat fitting can include a receptacle adapted to receive a pedestal seat support tube. The deck assembly can also include an integral receptacle adapted to receive a pedestal seat support tube.

In many embodiments, the deck assembly includes a deployable swim ladder. The deployable swim ladder can be coupled with the structure. The swim ladder can be coupled with the structure so as to provide a stowed configuration and a deployed configuration for the swim ladder. In the stowed configuration, the swim ladder can be disposed on top of the deck panel. In the deployed configuration, the swim ladder can extend from the bow of the boat. The swim ladder can be coupled with the structure via a hinged assembly that includes a first attachment member attached to the swim ladder, a central member rotationally coupled with the first attachment member, and a second attachment member rotationally coupled with the central member and attached to the structure. The structure can include an inclined surface adapted to support the swim ladder in the deployed configuration so that the swim ladder has a fixed inclined orientation relative to the structure. The swim ladder can be demountably attached to the structure. The structure can be adapted to support the swim ladder in the deployed configuration so that the swim ladder has a fixed orientation relative to the structure.

In many embodiments, the deck assembly includes an outboard motor mount. For example, the outboard motor mount can be coupled with the structure. The outboard motor mount can be demountably attached to the structure.

The deck assembly can include an anchor line management fitting. In many embodiments, the anchor line management fitting is attached to the structure. In many embodiments, the structure is disposed at a front end of the boat when the deck assembly is installed in the boat. As such, the anchor line management fitting can be suitably positioned at the bow of the boat so as to aid in the management of an anchor line extending from the bow of the boat.

The deck assembly can be adapted for installation in a variety of boat types. For example, the structure and the deck panel can be adapted to interface with at least one rigid hull member of the boat. And the structure and the deck panel can be adapted to interface with at least one inflatable portion of the boat.

In many embodiments, a boat is provided. The boat can include any of the above-described embodiments of deck assemblies. The boat can include a hull assembly that includes at least one of a rigid inflatable hull, a collapsible hull, an inflatable hull, or a non-collapsible hull.

In another aspect, a deck assembly for a boat is provided. The deck assembly includes a deck panel adapted for installation in a bow of the boat, and a deployable swim ladder coupled with the deck panel so as to provide a stowed configuration and a deployed configuration for the swim ladder. The swim ladder remains coupled with the deck between and in the stowed and deployed configurations. In the deployed configuration, the swim ladder extends from the bow of the boat. In the stowed configuration, the swim ladder can be disposed on top of the deck panel. In many embodiments, the deck assembly is permanently installed in a boat. In many embodiments, the deck assembly is removably installable in a boat.

In many embodiments, the swim ladder has a fixed orientation relative to the deck panel when in the deployed configuration. For example, the deck assembly can include a support member adapted to interface with the swim ladder in the deployed configuration so that the swim ladder has a fixed orientation relative to the deck panel.

In many embodiments, the swim ladder is coupled with the deck panel via a hinged assembly. The hinged assembly can have a first attachment member attached to the swim ladder, a central member rotationally coupled with the first attachment member, and a second attachment member rotationally coupled with the central member and coupled with the deck panel.

In many embodiments a boat is provided that includes any of the above-described deck assembly embodiments. The deck assembly can be removably attachable to the boat.

For a fuller understanding of the nature and advantages of the present invention, reference should be made to the ensuing detailed description and accompanying drawings.

### BRIEF DESCRIPTION OF THE DRAWINGS

FIG. 1 is an exploded perspective view of a boat and a removable deck assembly, in accordance with many embodiments.

FIG. 2 is a perspective view of the boat and deck assembly of FIG. 1 with the deck assembly installed, in accordance with many embodiments.

FIG. 3 is an exploded perspective view of a removable deck assembly having a deployable swim ladder, in accordance with many embodiments.

FIG. 4 is a perspective view of the deck assembly of FIG. 3 illustrating deployed and stowed configuration of the swim ladder, in accordance with many embodiments.

FIG. 5 is an exploded perspective view of a removable deck assembly having an attachable outboard motor mount, in accordance with many embodiments.

FIG. 6 is a perspective view of the deck assembly of FIG. 5 illustrating the installed position of the outboard motor mount, in accordance with many embodiments.

FIG. 7 is a perspective view of the deck assembly of FIG. 1 through FIG. 6 illustrating an attached fishing pole holder, an attached downrigger, and an attached rope cleat, in accordance with many embodiments.

FIG. 8 is a perspective view of a deck assembly installed in an inflatable boat, in accordance with many embodiments.

FIG. 9 is a side view of a deck assembly installed in an inflatable boat having an up-turned bow and inflatable seats, in accordance with many embodiments.

FIG. 10 is a perspective view of a portion of a deck assembly installed in a “Jon” boat, in accordance with many embodiments.

### DETAILED DESCRIPTION

In the following description, various embodiments of the present invention will be described. For purposes of explanation, specific configurations and details are set forth in order to provide a thorough understanding of the embodiments. However, it will also be apparent to one skilled in the art that the present invention may be practiced without the specific details. Furthermore, well-known features may be omitted or simplified in order not to obscure the embodiment being described.

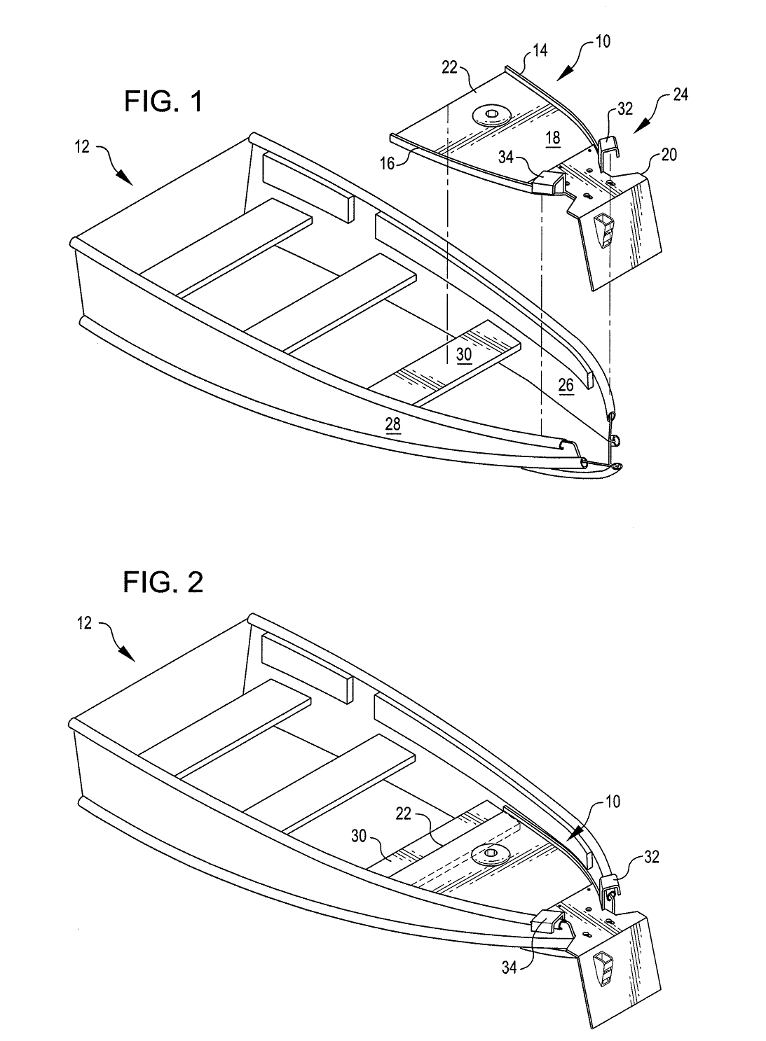

Referring now to the drawings, in which like reference numerals represent like parts throughout the several views, FIG. 1 shows a removable deck assembly 10 displaced relative to a boat 12, in accordance with many embodiments. The deck assembly 10 includes a port edge member 14, a starboard edge member 16, a deck panel 18, and a structure 20. The deck assembly has an aft end 22 and a forward end 24. The boat includes, in part, a port side hull member 26, a starboard side hull member 28, and a front seat 30.

In many embodiments, the deck assembly 10 is designed to be removably attached to the boat 12, and is stabilized relative to the boat 12 when attached. There are various ways to accomplish this, including supporting the aft end 22 of the deck assembly 10 on the front seat 30, supporting the aft end 22 of the deck assembly 10 using legs, or supporting the aft end 22 of the deck assembly 10 on bumpers in the boat 12 or that are installed in the boat 12. The forward end 24 can also be supported in various ways, including with legs, with bumpers or other configurations, or with fittings such as the fittings described below. In addition, the deck can wedge against the sidewalls of the boat hull, and may not include a separate structure for attachment to the boat.

In many embodiments, the structure 20 is attached to the deck panel 18 and includes an inverted J-shaped port support fitting 32 adapted to interface with the boat port side hull member 26 so as to provide vertical support to the deck assembly 10. And the structure 20 includes an inverted J-shaped starboard support fitting 34 adapted to interface with the boat starboard side hull member 28 so as to provide vertical support to the deck assembly.

The deck assembly 10 can be fabricated from suitable known materials having sufficient strength and stiffness. In many embodiments, the edge members 14, 16 are fabricated from an aluminum extrusion and are attached to the deck panel 18 via riveting. In many embodiments, the deck panel 18 is fabricated from a high-density plastic material (e.g., “SparAlloy UltraBoard” available from Regal Plastic Supply Company, Dallas, Tex.) and includes one or more aluminum stiffeners attached to a lower surface of the deck panel 18. In many embodiments, the deck panel 18 includes an anti-skid surface that is integrally formed into the high-density plastic material used. A suitable anti-skid material can also be applied when the deck panel 18 is fabricated from a material without an integral anti-skid surface. In many embodiments, the structure 20 is fabricated from stainless steel via welding.

FIG. 2 shows the deck assembly 10 installed in the boat 12. The illustrated boat 12 is a collapsible boat and the port and starboard sides of the boat 12 include two panels each, a lower one going up and out, and the upper one going mostly up (and slightly in at the bow). In many embodiments, the deck assembly 10 is installed so that the deck assembly 10 is locally trapped between the port and starboard junctions between the upper and lower panels. While the structure of the particular deck assembly 10 illustrated is suited for this collapsible boat, the deck assembly can be adapted for installation in other types of boats, for example, an inflatable boat as described below.

The deck assemblies disclosed herein can be installed in, for example, collapsible boats such as disclosed in U.S. Pat. Nos. 4,556,009; 4,660,499; and 5,524,570, the full disclosures of which are hereby incorporated herein by reference. For example, U.S. Pat. No. 5,524,570 discloses a collapsible boat having a pair of hingedly interconnected lower or bottom panels and a pair of side panels hinged to respective bottom or lower panels. The boat includes a flexible or yieldable diaphragm or flexible transom, which uses a unique seal for connecting the diaphragm or flexible transom to the panels of the boat.

In the installed configuration, the deck assembly aft end 22 is supported by the boat seat 30. And the port and starboard edge members 14, 16 interface with the boat port and starboard side hull members 26, 28, respectively, as described above. The port and starboard edge members can include at least one attachment feature to attach the edge member to the corresponding hull member. For example, each edge member 14, 16 can include one or more attachment fastener holes (not shown) located to align with corresponding holes in the port and starboard side hull members 26, 28. A removable fastener assembly, for example, a bolt, washer, and wing nut can be used to attach the edge members 14, 16 with the hull members 26, 28 at each of the attachment fastener holes. At the forward end 24 of the deck assembly 10, the deck assembly 10 is further supported via the port and starboard support fittings 32, 34, which are supported by the boat port and starboard side hull members 26, 28, respectively.

In many embodiments, the port and starboard edge members 14, 16 are configured to interface with the boat port and starboard side hull members 26, 28, respectively. For example, the port and starboard edge members 14, 16 can include interfacing surfaces shaped to match mating surfaces of the boat port and starboard side hull members 26, 28. Where the interfacing surfaces of the boat port and starboard side hull members 26, 28 are outwardly sloped (i.e., sloped so as to provide increased separation between the boat port and starboard side hull members at a vertically higher location as compared to a vertically lower location), the sloped interfacing surfaces can be used to provide vertical support to the deck assembly via the port and starboard edge members 14, 16. Additional or alternate features can be used to support the port and starboard edge members 14, 16 relative to the boat port and starboard side hull members 26, 28, for example, a support feature such as a support rail or one or more support fittings attached to the boat port and starboard side hull members 26, 28. One or more attachment features (e.g., removable fasteners and the like) can be used to secure the port and starboard edge members 14, 16 to the boat port and starboard side hull members 26, 28.

In many embodiments, the aft edge 22 of the deck assembly 10 is supported by the boat seat 30 when the deck assembly is installed. The aft edge 22, however, can also be supported in alternate ways. For example, the deck assembly 10 can include an aft edge stiffening member (not shown) to support the aft edge 22 of the deck assembly 10 relative to the boat hull. Such an aft edge stiffening member can be supported via the boat port and starboard side hull members 26, 28, and can be further supported by one or more structural members (not shown) disposed between the hull of the boat and the aft edge stiffening member. One or more attachment features (e.g., removable fasteners and the like) can also be used to secure the aft edge 22 of the deck assembly 10 relative to the boat seat 30 and/or the boat hull.

As illustrated in FIG. 2, the port and starboard support fittings 32, 34 are configured to fit over and against the upper edges of the boat port and starboard side hull members 26, 28, respectively. As such, the support fittings 32, 34 provide both vertical and two-directional lateral support to the deck assembly 10 relative to the boat port and starboard side hull members 26, 28 because the increasing spacing between the boat port and starboard side hull members in the aft direction serves to prevent forward and aft movement of the deck assembly 10.

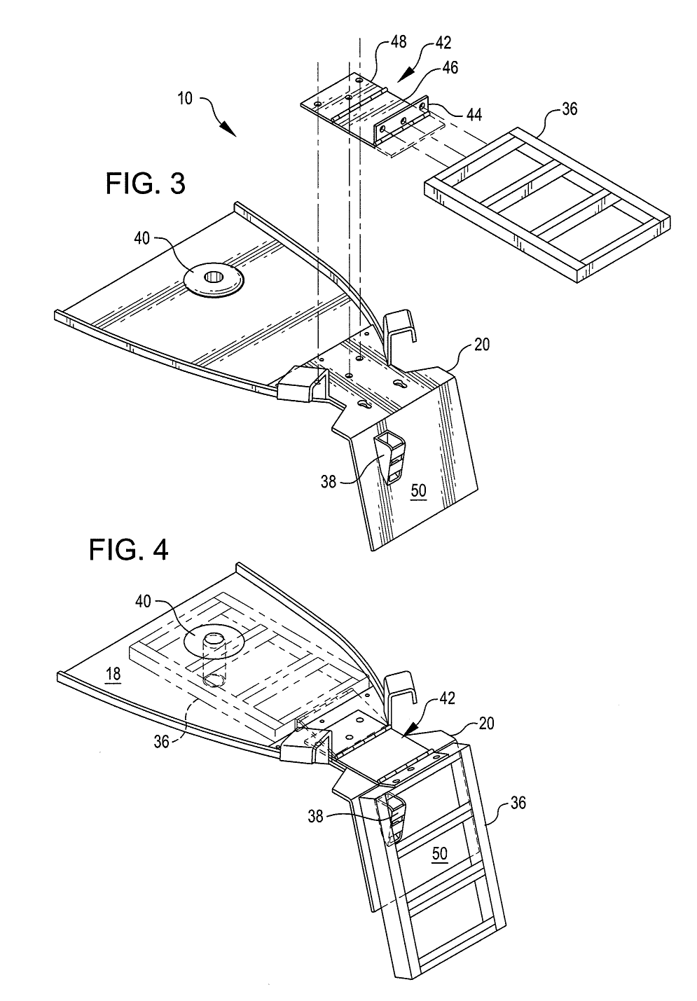

FIG. 3 illustrates some additional features of the deck assembly 10. These illustrated features include a deployable swim ladder 36, an anchor line management fitting 38, and a seat fitting 40.

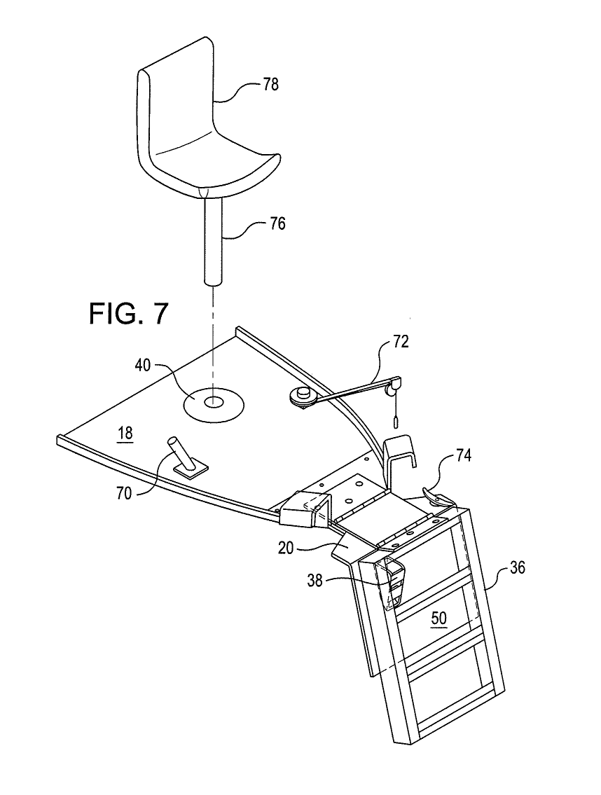

In many embodiments, the seat fitting 40 is a pedestal seat support fitting having a receptacle adapted to receive and support a pedestal seat support tube 76 (shown in FIG. 7) that supports a pedestal seat 78 (shown in FIG. 7). Such a pedestal seat can be configured to swivel a full 360 degrees relative to the deck assembly 10, and can be configured to raise and lower relative to the deck assembly 10.

The anchor line management fitting 38 can be configured to guide an anchor line, can include a locking mechanism to prevent extension of the anchor line, and can include one or more pulleys. The anchor line management fitting 38 can be attached to the structure 20 so as to not interfere with the deployed position of the swim ladder 36.

The swim ladder 36 is coupled with the structure 20 via a hinge assembly 42. The hinge assembly 42 includes a first attachment member 44 attached to the swim ladder 36, a central member 46 rotationally coupled with the first attachment member 44, and a second attachment member 48 rotationally coupled with the central member 46 and attached to the structure 20. The hinge assembly 42 can be attached to the swim ladder 36 and the structure 20 by using known attachment means (e.g., fasteners).

FIG. 4 illustrates deployed and stowed (in phantom lines) configurations of the swim ladder 36. In the deployed configuration, the swim ladder 36 is constrained in an inclined orientation by a combination of the hinge assembly 42 and an inclined surface 50 of the structure 20. As shown, the anchor line management fitting 38 is attached to the inclined surface 50 so as to be positioned clear of the swim ladder 36 in the deployed configuration. The anchor line management fitting 38 can be positioned so that the deployed configuration of the swim ladder 36 does not interfere with the use of the anchor line management fitting 38. For example, as shown in FIG. 4, the anchor line management fitting 38 can be arranged between steps and sides of the swim ladder 36 so that it is freely accessible through the ladder steps. In the stowed configuration, the swim ladder 36 is disposed on top of the deck panel 18. And the seat fitting 40 is positioned so as to be clear of the swim ladder 36 in the stowed configuration by locating the seat fitting between the steps and sides of the swim ladder 36 when the swim ladder 36 is in the stowed configuration.

The dual hinge arrangement of the hinge assembly 42 provides a number of advantages. For example, it permits the swim ladder 36 to be attached to the structure 20 further aft, thereby removing strain from the distal bow edge of the structure 20, and positions the hinges away from a motor mount (described below), when installed. The kinematics provided by the dual hinge arrangement also allows the swim ladder 36 to be stored flat on the deck panel 18, thereby making the storage of the swim ladder 36 easier.

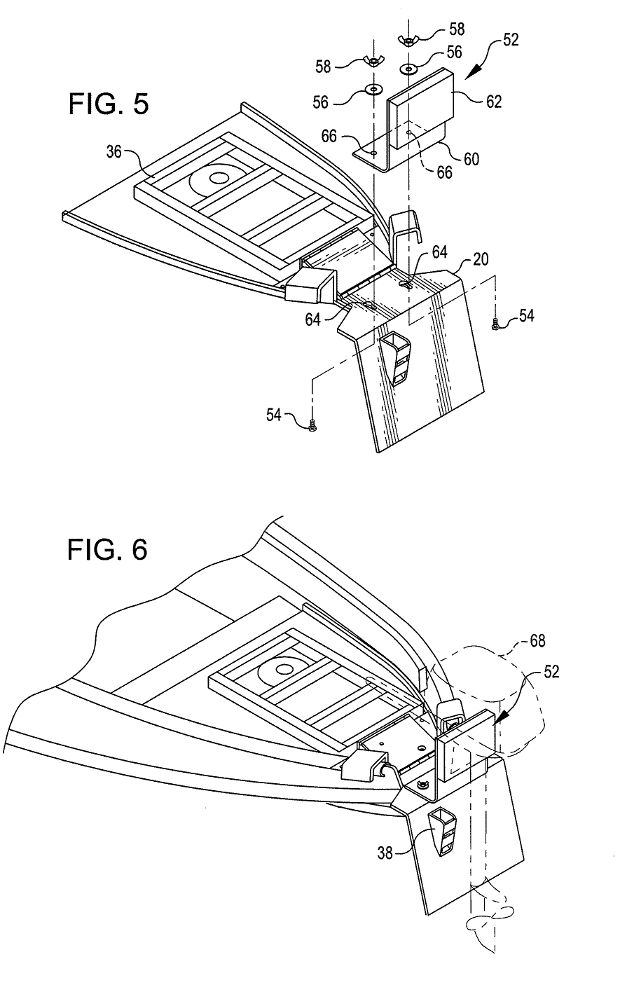

FIG. 5 illustrates the attachment of an outboard motor mount 52 to the structure 20 via attachment fasteners 54, washers 56, and wing nuts 58. The outboard motor mount 52 includes a frame 60 (e.g., a stainless steel frame) and an attached mount pad 62. The structure 20 includes two slotted attachment holes 64 configured to receive the heads of the attachment fasteners 54. The outboard motor mount 52 includes mounting holes 66 for the attachment fasteners 54. The slotted attachment holes 64 provide for the installation of the motor mount 52 without the need to remove the fasteners 54 from the mounting holes 66. To install the motor mount 52, the fasteners need only be loosened enough to insert the heads of the fasteners 54 in the wide portion of the slotted holes and then slide the fastener heads towards the narrow portion of the slotted holes. The deck assembly can include anti-rotation features to keep the fasteners 54 from rotating so that rotation of the wing nuts 58 is sufficient to secure the motor mount 52 to the structure 20. As illustrated in FIG. 6, the anchor line management fitting 38 is located to the side of an outboard motor 68 mounted to the outboard motor mount 52.

The deck assembly 10 can be designed so that the swim ladder 36 is deployable with the motor mount 52 installed. For example, the central member 46 of the hinge assembly 42 can be a frame that includes a central opening configured to provide clearance for the motor mount 52 when the swim ladder 36 is deployed (and while being deployed).

The deck assembly 10 can also incorporate additional features. For example, as illustrate in FIG. 7, a fishing pole holder 70 can be attached to the deck assembly 10 or integrally formed into the deck panel 18. And a downrigger 72 can be attached to the deck assembly 10 at a suitable location such as to the deck panel 18 as illustrated. And a rope cleat 74 can be attached to the deck assembly 10 at a suitable location such as to the structure 20 as illustrated. And the seat fitting 40 can be adapted to receive a pedestal seat support tube 76 that supports a pedestal seat 78.

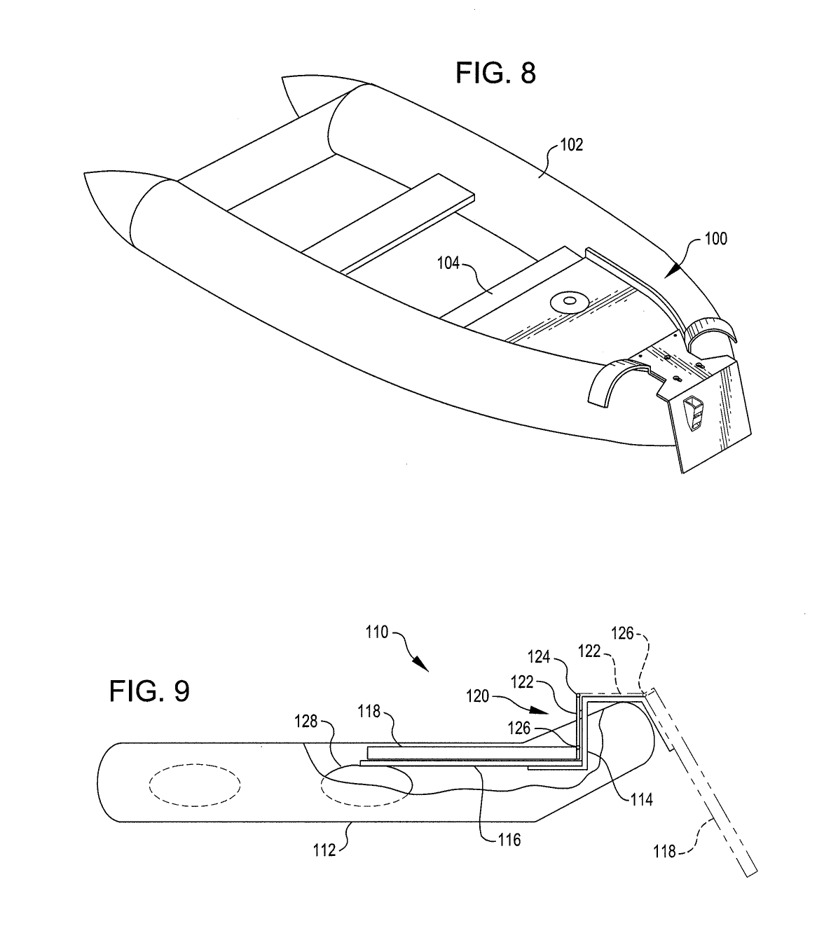

As will be apparent to a person skilled in the art, the disclosed deck assemblies can be adapted for use with a variety of boat configurations, including (but not limited to) rigid boats, collapsible boats, inflatable boats, rigid inflatable boats, and the like. For example, FIG. 8 illustrates a removable deck assembly 100 adapted for use with an inflatable boat 102, in accordance with many embodiments. Similar to the deck assembly 10 described above, the deck assembly 100 is partially supported via a front seat 104 of the inflatable boat 102. The deck assembly 100 can include any of the above-described features and components of the deck assembly 10 of FIG. 1 through FIG. 7.

As another example, FIG. 9 is a side view illustrating details of a removable deck assembly 110 installed in an inflatable boat 112 that has an up-turned bow, in accordance with many embodiments. The removable deck assembly 110 has a stepped configuration that elevates a top surface of a structure 114 above a deck panel 116. A deployable swim ladder 118 is shown in a stowed configuration and in a deployed configuration (in phantom lines). Similar to the above-described deck assembly 10, when in the stowed configuration, the swim ladder 118 is disposed on top of the deck panel 116. The swim ladder 118 is rotationally coupled with the structure 114 via a hinge assembly 120, which includes a hinge plate 122 that is rotationally coupled with the structure 114 via a hinge 124 and is rotationally coupled with the swim ladder 118 via a hinge 126. The deck assembly 110 can include any of the above-described features and components of the deck assemblies of FIG. 1 through FIG. 8. Similar to the deck assemblies described above, the deck assembly 110 is partially supported via a front seat 128 of the inflatable boat 112.

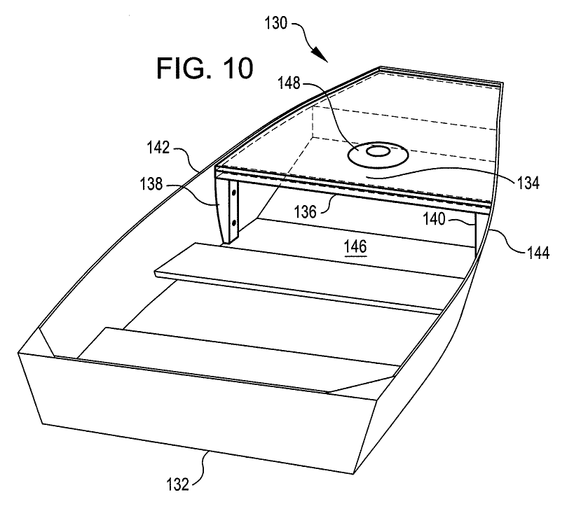

As yet another example, FIG. 10 partially illustrates a removable deck assembly 130 installed in a “Jon” boat 132, in accordance with many embodiments. The deck assembly 130 can include any of the above-described features and components of the deck assemblies of FIG. 1 through FIG. 9. Accordingly, the partial illustration in FIG. 10 omits some of the above-described features and components.

An aft portion 134 of the deck panel assembly 130 is not supported by a seat of the boat 132, but instead includes a support beam 136 that is supported by a port support fitting 138 and a starboard support fitting 140. The port and starboard support fittings 138, 140 can be fastened to a port side hull member 142 and a starboard side hull member 144, respectively. Alternate approaches can also be used to support the aft portion 134, for example, one or more support members disposed between a bottom 146 of the boat 132 and the aft portion 134. In addition to any of the above-described features and components, the deck panel can, as illustrated, include a pedestal seat fitting 148.

The above-described deck assemblies can also be permanently installed in a boat. For example, the deck assembly 130 can be permanently installed in the boat 132.

Other variations are within the spirit of the present invention. Thus, while the invention is susceptible to various modifications and alternative constructions, certain illustrated embodiments thereof are shown in the drawings and have been described above in detail. It should be understood, however, that there is no intention to limit the invention to the specific form or forms disclosed, but on the contrary, the intention is to cover all modifications, alternative constructions, and equivalents falling within the spirit and scope of the invention, as defined in the appended claims.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments of the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

All references, including publications, patent applications, and patents, cited herein are hereby incorporated by reference to the same extent as if each reference were individually and specifically indicated to be incorporated by reference and were set forth in its entirety herein.

What is claimed is:

1. A removable deck assembly for a boat, the deck assembly comprising:
a deck panel; and
a structure for removably attaching the deck panel in a bow of the boat, the structure supporting the deck panel in stable, substantially horizontal manner.

2. The deck assembly of claim 1, wherein an aft portion of the deck panel is adapted to be supported by a seat of the boat when the deck assembly is installed in the boat.

3. The deck assembly of claim 1, further comprising an aft support structure adapted to interface with a hull of the boat to support an aft portion of the deck panel when the deck assembly is installed in the boat.

4. The deck assembly of claim 1, further comprising:
a port edge member attached to the deck panel and contacting a port side hull member of the boat; and
a starboard edge member attached to the deck panel and contacting a starboard side hull member of the boat.

5. The deck assembly of claim 4, wherein the boat comprises a V-hull and the edge members wedge against an upper portion of the V-hull.

6. The deck assembly of claim 4, wherein each of the port and starboard edge members comprise at least one attachment feature to attach the edge member to the corresponding hull member.

7. The deck assembly of claim 1, wherein the structure comprises:
a port support fitting adapted to interface with a port side hull member of the boat so as to provide vertical support to the deck assembly; and
a starboard support fitting adapted to interface with a starboard side hull member of the boat so as to provide vertical support to the deck assembly.

8. The deck assembly of claim 7, wherein each of the port and starboard support fittings comprise an inverted J-shaped member adapted to interface with the corresponding hull member.

9. The deck assembly of claim 1, further comprising a seat fitting coupled with the deck panel and comprising a receptacle adapted to receive a pedestal seat support tube.

10. The deck assembly of claim 1, further comprising a deployable swim ladder coupled with the structure.

11. The deck assembly of claim 10, wherein the swim ladder is coupled with the structure so as to provide a stowed configuration and a deployed configuration for the swim ladder, the stowed configuration having the swim ladder disposed on top of the deck panel, the deployed configuration having the swim ladder extending from the bow of the boat.

12. The deck assembly of claim 11, wherein the swim ladder is coupled with the structure via a hinged assembly comprising:
a first attachment member attached to the swim ladder;
a central member rotationally coupled with the first attachment member; and
a second attachment member rotationally coupled with the central member and attached to the structure.

13. The deck assembly of claim 12, wherein the structure comprises an inclined surface adapted to support the swim ladder in the deployed configuration so that the swim ladder has a fixed inclined orientation relative to the structure.

14. The deck assembly of claim 11, wherein the swim ladder is demountably attached to the structure.

15. The deck assembly of claim 11, wherein the structure is adapted to support the swim ladder in the deployed configuration so that the swim ladder has a fixed orientation relative to the structure.

16. The deck assembly of claim 1, further comprising an outboard motor mount coupled with the structure.

17. The deck assembly of claim 16, wherein the outboard motor mount is demountably attached to the structure.

18. The deck assembly of claim 1, further comprising an anchor line management fitting attached to the structure.

19. The deck assembly of claim 1, wherein the structure and the deck panel are adapted to interface with at least one rigid hull member of the boat.

20. The deck assembly of claim 1, wherein the structure and the deck panel are adapted to interface with at least one inflatable portion of the boat.

21. A boat comprising the deck assembly of claim 1.

22. The boat of claim 21, wherein the boat comprises a hull assembly comprising at least one of a rigid inflatable hull, a collapsible hull, an inflatable hull, or a non-collapsible hull.

23. The boat of claim 21, further comprising at least one of:
a seat fitting coupled with the deck panel and comprising a receptacle adapted to receive a pedestal seat support tube;
a deployable swim ladder coupled with the structure so as to provide a stowed configuration and a deployed configuration for the swim ladder, the stowed configuration having the swim ladder disposed on top of the deck panel, the deployed configuration having the swim ladder extending from the bow of the boat; or
an outboard motor mount demountably attached to the structure.

24. A deck assembly for a boat, the deck assembly comprising:
a deck panel adapted for installation in a bow of the boat; and
a deployable swim ladder coupled with the deck panel so as to provide a stowed configuration and a deployed configuration for the swim ladder, the swim ladder remaining coupled with the deck between and in the stowed and deployed configurations, the deployed configuration having the swim ladder extending from the bow of the boat.

25. The deck assembly of claim 24, wherein the deck assembly is removably installable in the boat.

26. The deck assembly of claim 24, wherein the stowed configuration has the swim ladder disposed on top of the deck panel.

27. The deck assembly of claim 24, further comprising a support member adapted to interface with the swim ladder in the deployed configuration so that the swim ladder has a fixed orientation relative to the deck panel.

28. The deck assembly of claim 24, wherein the swim ladder is coupled with the deck panel via a hinged assembly comprising:
a first attachment member attached to the swim ladder;
a central member rotationally coupled with the first attachment member; and
a second attachment member rotationally coupled with the central member and coupled with the deck panel.

29. A boat comprising the deck assembly of claim 24.

30. The boat of claim 29, wherein the deck assembly is removably attachable to the boat.
